(19) United States
(12) Patent Application Publication
(10) Pub. No.: US 2008/0060239 A1
(43) Pub. Date: Mar. 13, 2008

(54) Non-permanent vehicle plate support assembly

(76) Inventor: Steven Harp, Germantown, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/502,733

(22) Filed: Aug. 12, 2006

(51) Int. Cl. G09F 21/04

(52) U.S. Cl. 40/591

(57) ABSTRACT

An apparatus comprised of a support plate adapted to support a vehicle plate, and at least one arm, each arm having a forward portion and a rearward portion, the forward portion supporting the support plate and the rearward portion non-permanently clamping the apparatus to a vehicle below the vehicle's grille. The apparatus can further include a pad disposed on each arm or on the back of the support plate to protect the vehicle from scratching. The arms can be a fixed length, adapted for a particular make and model of a vehicle, or the arms can be adjustable in length, adapted to fit multiple makes and models of vehicles. In an embodiment of the apparatus in which multiple arms are used, the arms can be connected with a crossbar, and the crossbar can further include one or more posts disposed thereon to aid in the non-permanent clamping of the apparatus to the vehicle.

### FIELD OF INVENTION

This invention relates generally to the field of vehicle plate support assemblies, and in particular to the field of vehicle plate support assemblies capable of being non-permanently secured to a vehicle.

### BRIEF DESCRIPTION OF THE DRAWINGS

FIG. 1 shows a top perspective view of one embodiment of the vehicle plate support assembly mounted to the front of a vehicle.

FIG. 2a shows a side view of one embodiment of a vehicle plate support assembly.

FIG. 2b shows a top perspective view of the embodiment of the vehicle plate support assembly shown in FIG. 2a.

FIG. 2c shows a top perspective view of an alternate embodiment of the vehicle plate support assembly.

FIG. 3 shows a side view of an alternate embodiment of the vehicle plate support assembly in which the arms are angled.

FIG. 4a shows a top perspective view of an alternate embodiment of the arms.

FIG. 4b shows a top view of a portion of the embodiment of vehicle plate support assembly 100 shown in FIG. 4a.

FIGS. 5a through 5d show top perspective views of four (4) alternate embodiments of a support plate.

FIG. 6 shows a top perspective view of one alternate embodiment of a vehicle plate support assembly in which the arm is constructed or formed of a single piece.

FIG. 7 shows an alternate embodiment of a vehicle plate support assembly in which the vehicle plate support assembly is constructed with two (2) arms, but in which each arm is constructed of only one piece

FIG. 8 shows a top perspective view of one alternate embodiment of a vehicle plate support assembly in which arms are integrally formed with the support plate and in which the arms' length can be adjusted.

### DETAILED DESCRIPTION OF EMBODIMENTS OF THE INVENTION

For the purpose of promoting an understanding of the present invention, references are made in the text hereof to embodiments of a vehicle plate support assembly, some of which are depicted in the figures. It should nevertheless be understood that no limitations on the scope of the invention are thereby intended. One of ordinary skill in the art will readily appreciate that modifications such as those involving the number of components, positioning of the components relative to one another, materials from which the components are made, the size of the components, and the inclusion of additional elements do not depart from the spirit and scope of the present invention. Some of these possible modifications are mentioned in the following description. In addition, in the embodiments depicted herein, like reference numerals refer to identical structural elements in the various drawings. Therefore, specific details disclosed herein are not to be interpreted as limiting, but rather as a basis for the claims and as a representative basis for teaching one skilled in the art to employ the present invention in virtually any appropriately detailed system, structure, or manner.

Moreover, the term “substantially” or “approximately” as used herein may be applied to modify any quantitative representation that could permissibly vary without resulting in a change in the basic function to which it is related. For example, one embodiment of a vehicle plate support assembly is disclosed herein as including two (2) arms positioned substantially parallel to the ground and generally perpendicular to the support plate. The arms might permissibly be somewhat non-parallelly and/or non-perpendicularly disposed behind the support plate and still be within the scope of the invention if its functionality is not materially altered.

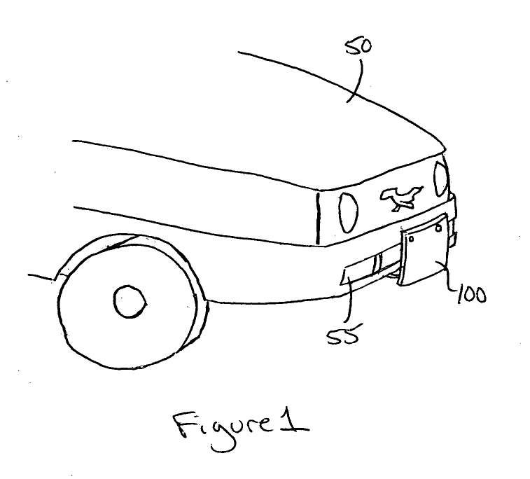

FIG. 1 shows a top perspective view of one embodiment of vehicle plate support assembly 100 mounted to the front of vehicle 50. Vehicle plate support assembly 100 is non-permanently secured to vehicle 50 below vehicle grille opening 55, either to a portion of the underside of vehicle 50 or to a portion of vehicle bumper 60, referred to herein as under or below the vehicle grille. As used herein, “non-permanently” and “temporarily” refer to a vehicle plate support assembly that can be removed from vehicle 50 without the use of tools, but still engages vehicle 50 while vehicle 50 is in operation. It should also be understood that the term “plate” should not be limited to state-issued or government-issued vehicle identification plates (i.e., license plates). Rather, the term means any smooth, flat, and/or rigid body of generally uniform thickness and made of metal, plastic, rubber, paperboard, or other material prepared for use as a printing surface, and includes any sign that is desired to be temporarily secured to a vehicle. Examples include signs for a parade (e.g., “Troop 158” or “FDNY”); a work crew may wish to put up a sign advertising the name of the company (e.g., “A&B Paving”); car dealer indicia; a safety marker (e.g., “Caution. Work Crew”); and racing indicia (e.g., the racer's name or number). It should also be understood that the plate can also be of any size and not limited only to standard sized license plates.

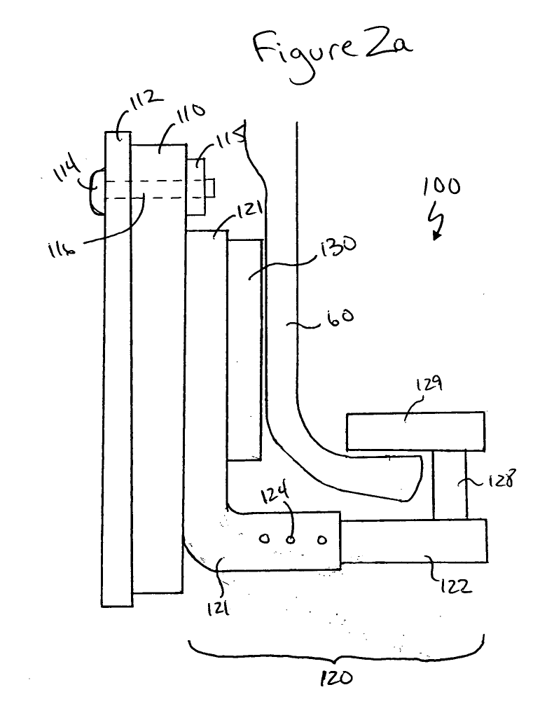

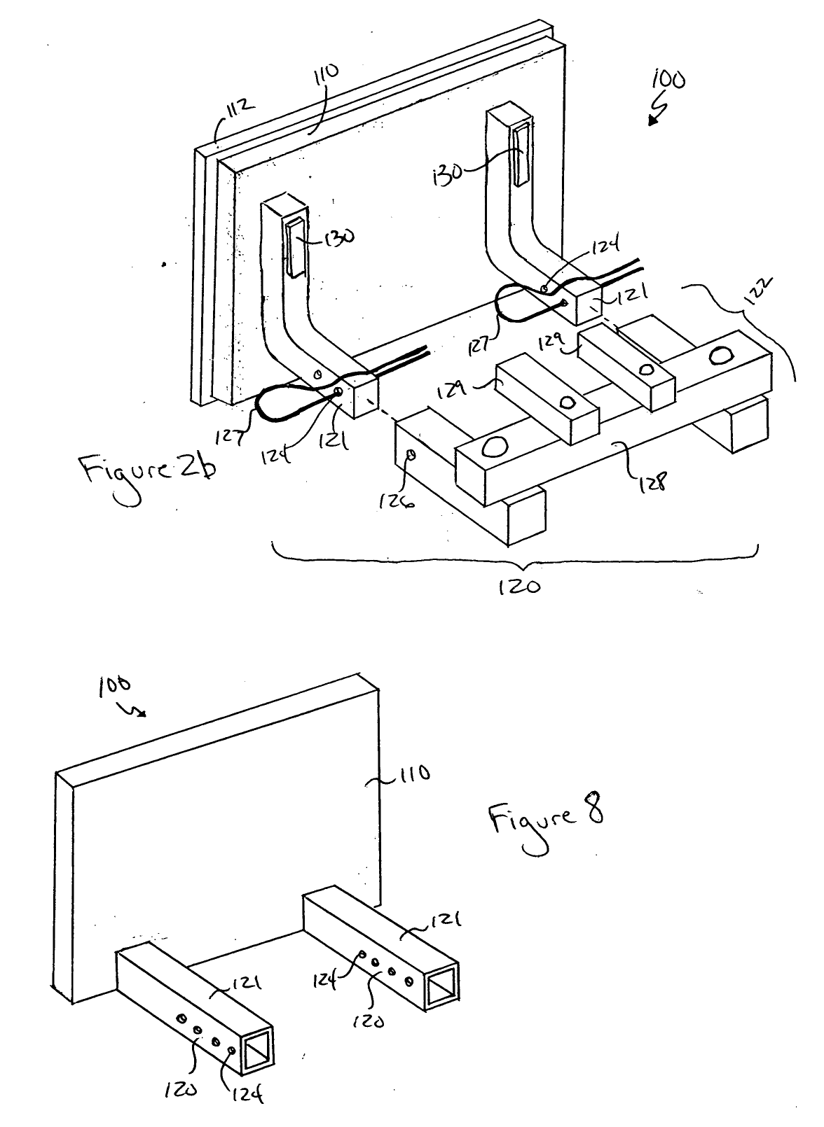

FIG. 2a shows a side view of one embodiment of vehicle plate support assembly 100. As can be seen, vehicle plate support assembly 100 is comprised of support plate 110, arm 120, and pad 130. Although not visible from this perspective, there are two (2) arms 120, each of which has pad 130 disposed thereon. Vehicle plate support assembly 100 is non-permanently clamped to vehicle bumper 60 and can be removed or positioned on the vehicle (not shown) without the use of tools. Although not shown, in an alternate embodiment of vehicle plate support assembly 100, rearward portion 122 (discussed in detail infra) of arm 120 could be permanently secured to the vehicle or the vehicle could be formed with rearward portion 122 of arm 120 (or an equivalent thereof) either already disposed thereon, to which forward portion 121 of arm 120 can be non-permanently secured.

FIG. 2b shows a side perspective view of the embodiment of vehicle plate support assembly 100 shown in FIG. 2a so that each arm 120 and each pad 130 can be appreciated. As can also be seen, arms 130 are adjustable in length to facilitate changing the length of arm 120 so that vehicle plate support assembly 100 can be used with multiple vehicle makes and models. As one (1) non-limiting example, the embodiment shown is particularly suited for a 2005 Ford Mustang. Forward portion 121 of arm 120 extends rearward, and rearward portion 122 of arm is shaped so that forward portion 121 can be positioned within rearward portion 122. However, it should be understood that rearward portion 122 could also be the male portion and forward portion 121 could be the female portion. Moreover, forward portion 121 and rearward portion 122 could be generally square-shaped, as in the embodiment shown in FIGS. 2a and 2b, generally cylindrical in shape, or any other shape that facilitates forward portion 121 or rearward portion 122 fitting within the other.

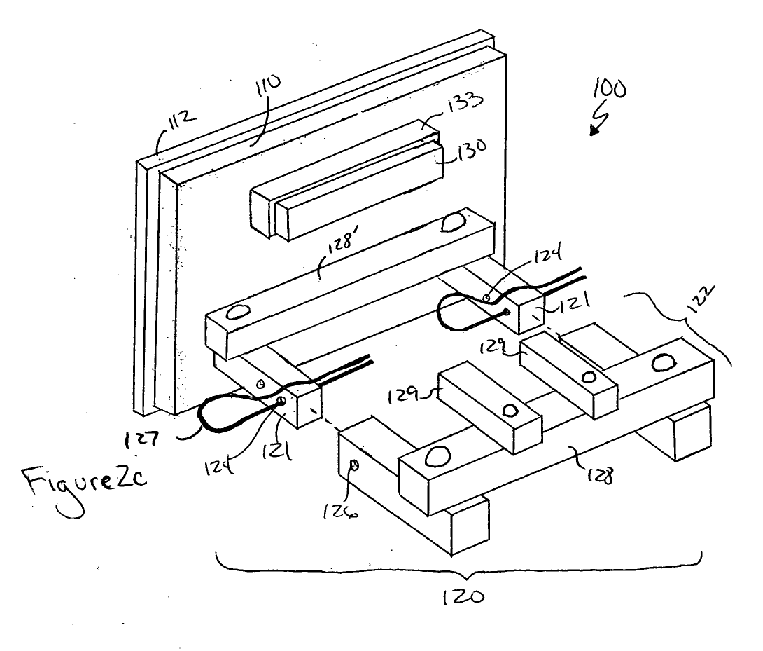

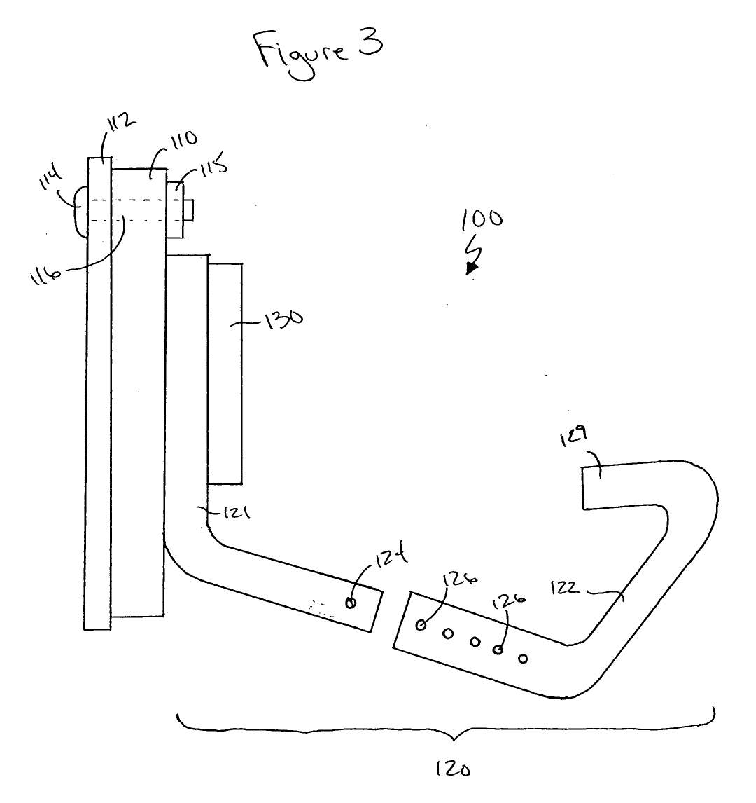

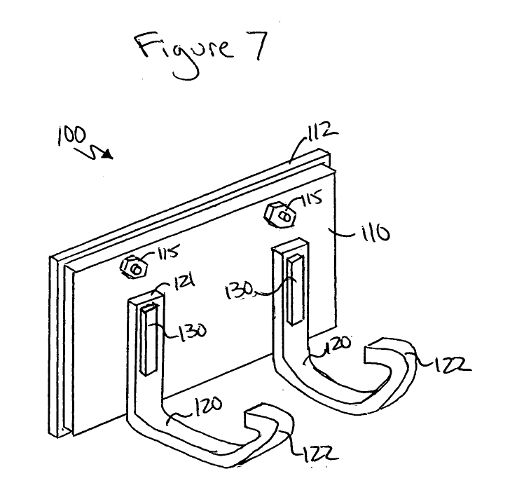

Also visible in FIG. 2b are crossbar 128 and posts 129. Crossbar 128 mechanically connects each rearward portion 122 of each arm 120. Crossbar 128 adds to the stability of vehicle plate support assembly 100, but is not a necessary component. In this embodiment, posts 129 help in the clamping of vehicle plate support assembly 100 to the vehicle. Rearward portion 122 of arm 120, can be constructed of multiple pieces (as shown in FIGS. 2a, 2b, 2c, and 4a), constructed of a single piece (as shown in FIG. 3, discussed in detail infra), or as a single piece with forward portion 121 of arm 120 (as shown in FIGS. 6 and 7, also discussed in detail infra), and need not be of any particular configuration, but need only be shaped to help clamp vehicle plate support assembly 100 to the vehicle.

Referring to FIG. 2a, support plate 110 provides a foundation to which vehicle plate 112 can be secured. Vehicle plate 112 is secured to the front surface of support plate 110 using bolt 114, which penetrates throughhole 116 of support plate 110, and nut 115. One of ordinary skill in the art will recognize that vehicle plate 112 can be secured to support plate 110 by any other mechanism, permanent or non-permanent. In the embodiment shown, support plate 110 and arms 120 are made of aluminum. However, support plate 110 and arms 120 could alternately be made of a durable plastic, Plexiglas, wood, steel, stainless steel, or any other material strong enough to support vehicle plate 112 and maintain its shape without being brittle, and combinations thereof. In the embodiment shown, support plate 110 is secured to the front surface of forward portion 121 of arm 120 by welding, but could also be secured using bolts, screws, an epoxy, or any other mechanism known in the art, including combinations thereof. In addition, in the embodiment shown in FIGS. 2a and 2b, pad 130 is secured to the back surface of arm 120. Pad 130 reduces the chance of vehicle plate support assembly 100 scratching the vehicle bumper 60 (visible in FIG. 2a). In the embodiment shown, pad 130 is made of window insulation, but could alternatively be made of foam rubber, leather, foam, rubber, or any other material capable of absorbing some of the pressure between vehicle plate support assembly 100 and the vehicle, including combinations thereof. Pad 130 is secured to support plate 110 using an epoxy in the embodiment shown, but could alternately be secured using an adhesive or any other mechanism commonly employed in the art.

In addition, holes 124 on forward portion 121 of arm 120 and hole 126 on rearward portion 122 of arm 120 can also be appreciated in FIGS. 2a and 2b. Once forward portion 121 of arm 120 is positioned within rearward portion 122 of arm 120, the two are locked in position by passing cotter pin 127 through one (1) of holes 126 and hole 124 to lock rearward portion 122 of arm 120 in place relative to forward portion 121 of arm 120. Cotter pin 127 can then be removed without the use of a tool, and the position of rearward portion 122 of arm 120 relative to forward portion 121 of arm 120 can be adjusted or repositioned, allowing vehicle plate support assembly 100 to be used on another vehicle (not shown).

It should also be understood that there could alternately be multiple holes 126 on rearward portion 122 of arm 120 and a single hole 124 on forward portion 121 of arm 120, or multiple holes 124, 126 on both forward portion 121 and rearward portion 122 of arm 120 and further alternately that forward portion 121 of arm 120 and rearward portion 122 of arm 120 could each only include a single hole 124, 126, though this would allow for only a particular length of arm 120. However, this may be necessary for a construction of vehicle plate support assembly 100 designed for a particular model of vehicle, but one in which a multi-part arm 120 is required to adapt to the particular construction of the vehicle.

It should be further understood that use of cotter pin 127 to temporarily lock forward portion 121 and rearward portion 122 in place is only one type of temporary locking mechanism. The temporary locking mechanism could also be a bolt, a lock, a pin and a cotter key, a clevis pin, a detent ring pin, a lanyard, a lock pin, a split key ring, a double loop hair pin, a circle cotter, a kickout ring, a lynch pin, a crimp ring retainer, a spring ball plunger, a ball plunger, or any other locking mechanism known in the art, including combinations thereof. Moreover, any other arm length adjusting mechanism well-known in the art that allows for the length of arm 120 to be changed could alternately be employed.

FIG. 2c shows a top perspective view of an alternate embodiment of vehicle plate support assembly 100. Vehicle plate 112, support plate 110, pad 130 and pad plate 133 (discussed in detail infra with respect to FIG. 6), rearward portion 122 of arms 120, holes 124 on forward portion 121 of arms 120, crossbar 128, posts 129, and cotter pins 127 are all the same as the embodiment of vehicle plate support assembly 100 shown in FIG. 2b. However, an alternate embodiment of forward portion 121 of arms 120 is shown in FIG. 2c. In this embodiment, each forward portion 121 of arms 120 is welded perpendicularly to support plate 110, and each forward portion 121 of arms 120 further includes crossbar 128′, which adds to the stability of vehicle plate support assembly 100.

FIG. 3 shows a side view of an alternate embodiment of vehicle plate support assembly 100 in which arms 120 are angled. In this embodiment, arms 120 are constructed such that the length of arms 120 are substantially non-perpendicular to with support plate 110 to allow vehicle plate support assembly 100 to be compatible with alternate vehicle's bumper (not shown) shapes. As with the embodiment of vehicle plate support assembly 100 shown in FIGS. 2a and 2b, arms 120 are adjustable in length to facilitate changing the length of arm 120 so that vehicle plate support assembly 100 can be used with multiple vehicle makes and models. Forward portion 121 of arm 120 extends rearward and is shaped so that forward portion 121 can be positioned within rearward portion 122.

FIG. 4a shows a top perspective view of an alternate embodiment of arms 120. In order to show this embodiment of arms 120, the support plate is not shown, but would be molded with or secured to forward portions 121 of arms 120. In this embodiment, forward portion 121 of arm 120 has one (1) hole 124 disposed thereon. Rearward portion 122 can also be appreciated and also has multiple holes 126 disposed thereon. Each rearward portion 122 of arms 120 is mechanically connected using an alternate type of crossbar 128 which includes posts 129 disposed thereon. In the embodiment shown, posts 129 are square-shaped. However, it should be understood that posts 129 could alternately be cylindrical, hexagonal, or any other shape. In addition, vehicle plate support assembly 100 is constructed with posts 129 positioned generally parallel with arms 120. It should be understood that posts 129 could be angles upward or downward, depending on the particular vehicle with which vehicle plate support assembly 100 is to be used.

Forward portion 121 and rearward portion 122 are mechanically connected to one another, in an a manner in which the length of arms 120 can be adjusted, using pins 125. In this manner, neither forward portion 121 or rearward portion 122 is a male or female connector, as can clearly be seen in FIG. 4b. FIG. 4b shows a top view of a portion of the embodiment of vehicle plate support assembly 100 shown in FIG. 4a taken along line 4b-4b to more clearly show the engagement between forward portion 121 and rearward portion 122 of arms 120.

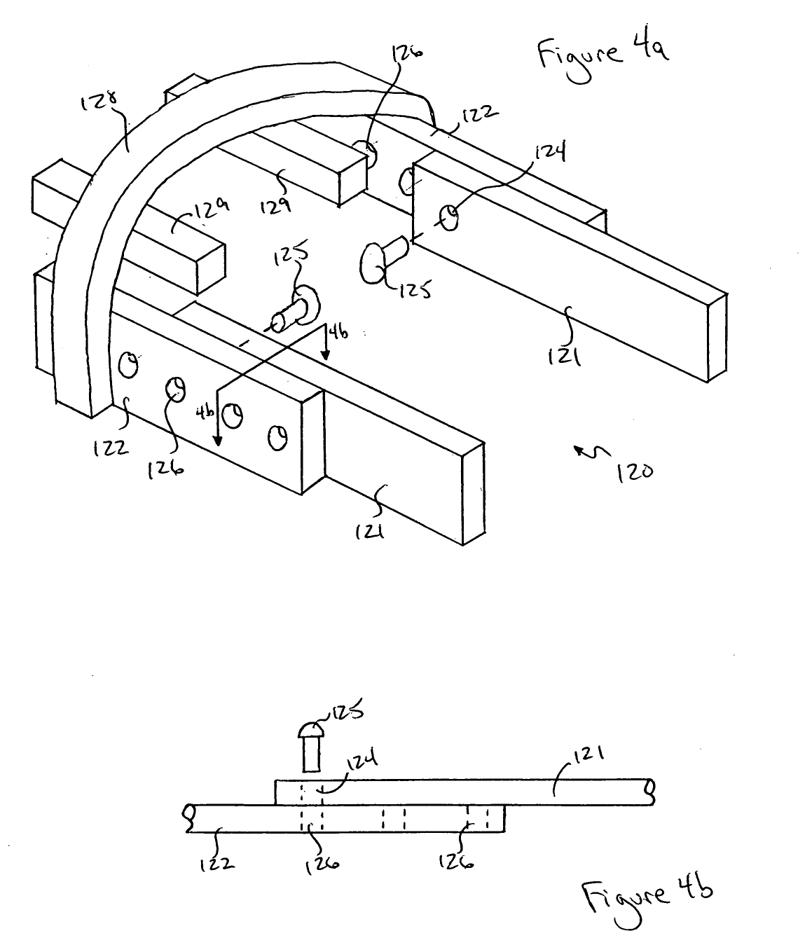

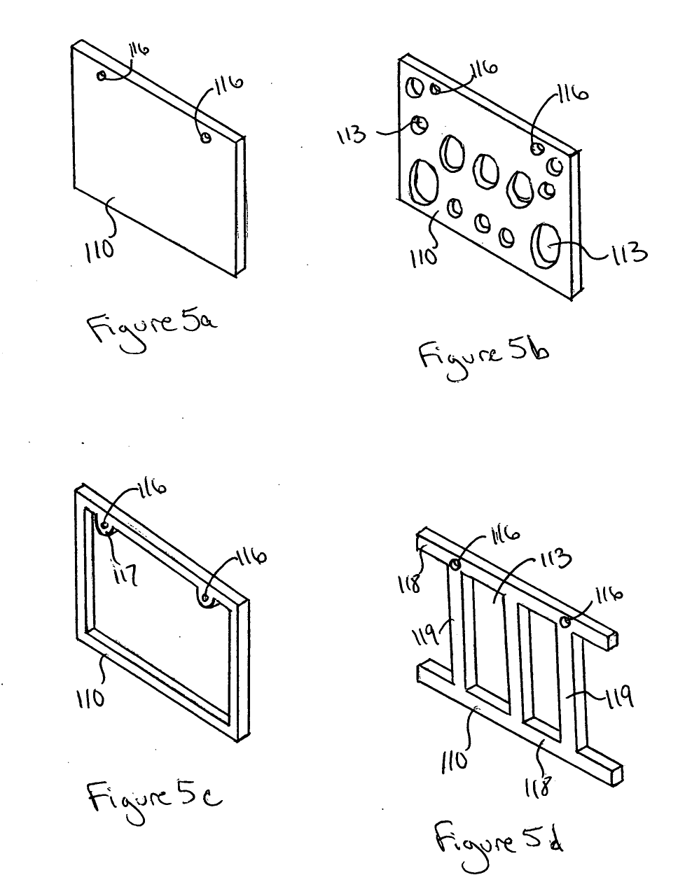

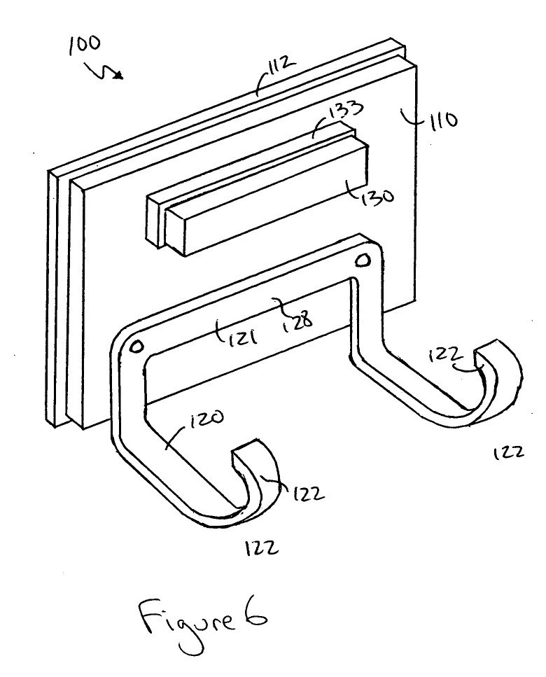

FIGS. 5a-5d show four (4) alternate embodiments of support plate 110. Support plate 110 is solid, except for throughholes 116 which are used to secure the vehicle plate (not shown) to support plate 110, in the embodiment shown in FIG. 5a. FIG. 5b shows an embodiment of support plate 110 with a plurality of apertures 113 disposed thereon to reduce the weight and cost of support plate 110. In FIG. 5c, support plate 110 is comprised only of a frame and two (2) tabs 117 for mounting the plate thereto. The embodiment of support plate 110 shown in FIG. 5c could also be construed to include a single substantially rectangular-shaped hole to reduce weight and cost. However, as with all of the embodiments of support plate 110 and vehicle plate support assembly 100 disclosed herein, the use of two (2) tabs is only exemplary and not intended to be limiting. FIG. 5d shows an alternate embodiment of support plate 110 comprised of two (2) horizontal brackets 118 and three (3) vertical brackets 119, forming two (2) substantially rectangular-shaped apertures 113. It should be understood that alternate numbers of horizontal brackets 118 and vertical brackets 119 could be employed, including a single horizontal bracket 118 and/or vertical bracket 119. One of ordinary skill in the art should recognize that the four (4) embodiments of support plate 110 depicted in FIGS. 5a-5d are intended to be non-limiting examples and that alternate constructions of support plate 110 do not depart from the spirit and scope of the invention.

FIG. 6 shows one alternate embodiment of vehicle plate support assembly 100 in which the two (2) arms 120 are constructed or formed as a single piece, i.e., in which arms 120 and crossbar 128 are constructed as a single piece. Also visible are pad 130 and pad plate 133. Because pad 130 is not positioned on the back surface of forward portion 121 of arm 130, due to the thickness of arms 120 and crossbar 128, forward portion 121 of arm 130 could contact the vehicle (not shown) when vehicle plate support assembly 100 is installed. To minimize the chance of scratching or otherwise damaging the vehicle, pad 130 is positioned on pad plate and pad plate 133 is secured to the back surface of support plate 110 by welding, but could alternately be secured using injection molding or another casting process, an epoxy or other adhesive, or any other mechanism known in the art, including combinations thereof. Moreover, in an alternate construction of support plate 110, support plate 110 and pad plate 133 are formed as one integral unit, making the step of securing pad plate 133 to support plate unnecessary.

FIG. 7 shows an alternate embodiment of vehicle plate support assembly 100 in which vehicle plate support assembly 100 is constructed with two (2) arms 120, but in which each arm 120 is constructed of only one (1) piece. In this embodiment, each arm 120 has pad 130 disposed thereon to prevent forward portions 121 of arms 120 from scratching the vehicle (not shown).

In addition, vehicle plate support assembly 100 and arms 120 could also be integrally formed with support plate 110, either with a fixed-length arm 120 or with just the male or female portions of an adjustable-length arm 120. FIG. 8 shows a top perspective view of one alternate embodiment of support plate 110 in which forward portions 121 of arms 120 are integrally formed with support plate 110. Like the embodiment shown and described with respect to FIG. 3, the length of arms 120 can be adjusted, though only forward portions 121 of arms 120 are shown. In the embodiment of arms 120 shown in FIG. 8, forward portions 121 of arms 120 are the female end, and the rearward portions (not shown) would be the male end. Although not shown, the rearward portion of each arm 120 is adapted to fit within forward portion 121 of each arm 120 and locked in position using a cotter pin (also not shown). However, one of ordinary skill will readily understand that forward portion 121 of arm 120 can be locked in position with respect to the rearward portion of arms 120 by any of the mechanisms discussed supra, or that the construction of arms 120 could be that of any of those alternates discussed supra, i.e., male-female (FIG. 2b), female-male (FIG. 2a and as shown in the embodiment depicted in FIG. 8), or side-by-side (FIG. 4a). In addition, holes 124 on forward portion 121 of arm 120 can also be appreciated.

While the vehicle plate support assembly has been shown and described with respect to several embodiments in accordance with the present invention, it is to be understood that the same is not limited thereto, but is susceptible to numerous changes and modifications as known to a person skilled in the art, and it is intended that the present invention not be limited to the details shown and described herein, but rather cover all such changes and modifications obvious to one of ordinary skill in the art.

What is claimed is:

1. An apparatus comprised of:
a support plate adapted to support a vehicle plate; and
at least one arm, each of said at least one arm comprised of a forward portion and a rearward portion, wherein each forward portion of said at least one arm is adapted to support said vehicle plate, and wherein each rearward portion of said at least one arm is adapted to non-permanently clamp said apparatus to a vehicle below a grille of said vehicle.

2. The apparatus of claim 1, wherein said apparatus is further comprised of at least one pad positioned on a back surface of said support plate to prevent said support plate from contacting said vehicle.

3. The apparatus of claim 2, wherein said apparatus is further comprised of at least one pad support positioned on said back surface of said support plate, said at least one pad positioned on said pad support.

4. The apparatus of claim 2, wherein said pad is made of a material selected from a group comprised of window insulation, foam rubber, leather, foam, rubber, and combinations thereof.

5. The apparatus of claim 1, wherein said apparatus is further comprised of at least one pad positioned on a back surface of one of said at least one arm to prevent said at least one arm from contacting said vehicle.

6. The apparatus of claim 5, wherein said at least one pad is made of a material selected from a group comprised of window insulation, foam rubber, leather, foam, rubber, and combinations thereof

7. The apparatus of claim 1, wherein said vehicle plate is selected from a group comprised of a government-issued vehicle identification plates, a promotional design, an advertisement, a car dealer indicia, a safety marker, racing indicia, and combinations thereof.

8. The apparatus of claim 1, wherein said support plate is constructed of a material selected from a group comprised of aluminum, plastic, Plexiglas, wood, steel, stainless steel, and combinations thereof.

9. The apparatus of claim 1, wherein each of said at least one arm is made of a material selected from a group comprised of aluminum, plastic, Plexiglas, wood, steel, stainless steel, and combinations thereof.

10. The apparatus of claim 1, wherein each of said at least one arm and said support plate are constructed as one integral unit.

11. The apparatus of claim 1, wherein each of said at least one arm is adjustable in length using an arm length adjusting mechanism.

12. The apparatus of claim 11, wherein said arm length adjusting mechanism is selected from a group comprised of a cotter pin, a bolt, a lock, a pin and a cotter key, a clevis pin, a detent ring pin, a lanyard, a lock pin, a split key ring, a double loop hair pin, a circle cotter, a kickout ring, a lynch pin, a crimp ring retainer, a spring ball plunger, a ball plunger, and including combinations thereof.

13. The apparatus of claim 1, wherein each rearward portion is permanently secured to said vehicle or integrated to said vehicle.

14. The apparatus of claim 1, wherein each of said at least one arm is connected by a crossbar.

15. The apparatus of claim 14, wherein said apparatus is further comprised of at least one post disposed on said crossbar, said at least one post adapted to functionally engage said vehicle below a grille of said vehicle

16. The apparatus of claim 1, wherein said support plate is comprised of at least one aperture.

17. A vehicle plate support assembly comprised of:
at least one arm, each of said at least one arm comprised of a forward portion and a rearward portion, said forward portion having a front surface and a back surface, and wherein each rearward portion of said at least one arm is adapted to non-permanently and functionally engage a vehicle below a grille of said vehicle;
a support plate adapted to support a vehicle plate, said support plate having a front surface and a back surface, said support plate disposed on said front surface of said forward portion of each of said at least one arm; and
at least one pad, one of said at least one pad disposed on said back surface of said forward portion of each of said at least one arm or to said back surface of said support plate;
wherein said vehicle plate support assembly non-permanently mechanically clamps said vehicle between each of said at least one arm and said at least one pad.

18. The apparatus of claim 17, wherein said a least one pad is made of a material selected from a group comprised of window insulation, foam rubber, leather, foam, rubber, and combinations thereof.

19. The apparatus of claim 17, wherein said apparatus is further comprised of a pad support, said pad positioned on said pad support.

20. The apparatus of claim 17, wherein said vehicle plate is selected from a group comprised of a government-issued vehicle identification plates, a promotional design, an advertisement, a car dealer indicia, a safety marker, racing indicia, and combinations thereof.

21. The apparatus of claim 17, wherein said support plate is constructed of a material selected from a group comprised of aluminum, plastic, Plexiglas, wood, steel, stainless steel, and combinations thereof.

22. The apparatus of claim 17, wherein each of said at least one arm is made of a material selected from a group comprised of aluminum, plastic, Plexiglas, wood, steel, stainless steel, and combinations thereof.

23. The apparatus of claim 17, wherein each of said at least one arm and said support plate are constructed as one integral unit.

24. The apparatus of claim 17, wherein each of said at least one arm is adjustable in length using an arm length adjusting mechanism.

25. The apparatus of claim 24, wherein said arm length adjusting mechanism is selected from a group comprised of a cotter pin, a bolt, a lock, a pin and a cotter key, a clevis pin, a detent ring pin, a lanyard, a lock pin, a split key ring, a double loop hair pin, a circle cotter, a kickout ring, a lynch pin, a crimp ring retainer, a spring ball plunger, a ball plunger, and including combinations thereof.

26. The apparatus of claim 17, wherein each rearward portion is permanently secured to said vehicle or integrated to said vehicle.

27. The apparatus of claim 17, wherein each of said at least one arm is connected by a crossbar.

28. The apparatus of claim 27, wherein said apparatus is further comprised of at least one post disposed on said crossbar, said at least one post adapted to functionally engage said vehicle below a grille of said vehicle.

29. The apparatus of claim 17, wherein said support plate is comprised of at least one aperture.

30. A license plate support assembly for non-permanently mounting a vehicle plate to a front end of a vehicle comprised of:
a first arm and a second arm, said first arm and said second arm each comprised of a forward portion and a rearward portion, each of said forward portions having a front surface and a back surface, and wherein each rearward portion of said at least one arm is adapted to clamp said license plate support assembly to said vehicle below a grille of said vehicle;
a support plate adapted to support said vehicle plate, said support plate having a front surface and a back surface, said support plate disposed on each of said front surfaces of each of said forward portions of said first arm and said second arm; and
a pad disposed on said back surface of said support plate.

31. The apparatus of claim 30, wherein said pad is made of a material selected from a group comprised of window insulation, foam rubber, leather, foam, rubber, and combinations thereof.

32. The apparatus of claim 30, wherein said apparatus is further comprised of a pad support, said pad positioned on said pad support.

33. The apparatus of claim 30, wherein said vehicle plate is selected from a group comprised of a government-issued vehicle identification plates, a promotional design, an advertisement, a car dealer indicia, a safety marker, racing indicia, and combinations thereof.

34. The apparatus of claim 30, wherein said support plate is constructed of a material selected from a group comprised of aluminum, plastic, Plexiglas, wood, steel, stainless steel, and combinations thereof.

35. The apparatus of claim 30, wherein said first arm and said second arm are made of a material selected from a group comprised of aluminum, plastic, Plexiglas, wood, steel, stainless steel, and combinations thereof.

36. The apparatus of claim 30, wherein said first arm, said second arm, and said support plate are constructed as one integral unit.

37. The apparatus of claim 30, wherein said first arm and said second arm are adjustable in length using an arm length adjusting mechanism.

38. The apparatus of claim 37, wherein said arm length adjusting mechanism is selected from a group comprised of a cotter pin, a bolt, a lock, a pin and a cotter key, a clevis pin, a detent ring pin, a lanyard, a lock pin, a split key ring, a double loop hair pin, a circle cotter, a kickout ring, a lynch pin, a crimp ring retainer, a spring ball plunger, a ball plunger, and including combinations thereof.

39. The apparatus of claim 30, wherein each rearward portion is permanently secured to said vehicle or integrated to said vehicle.

40. The apparatus of claim 30, wherein said first arm and said second arm are connected by a crossbar.

41. The apparatus of claim 40, wherein said apparatus is further comprised of at least one post disposed on said crossbar, said at least one post adapted to functionally engage said vehicle below a grille of said vehicle.

42. The apparatus of claim 30, wherein said support plate is comprised of at least one aperture.

43. A device for non-permanently mounting a vehicle plate to a front end of a vehicle comprised of:
a first arm and a second arm, said first arm and said second arm each comprised of a forward portion and a rearward portion, each of said forward portions having a front surface and a back surface, and wherein each rearward portion of said at least one arm is adapted to functionally engage said vehicle below a grille of said vehicle, wherein each of said at least one arm is adjustable in length using an arm length adjusting mechanism;
at least one crossbar connecting said first arm to said second arm;
a first post and a second post positioned on said at least one crossbar, said first post and said second post adapted to clamp said device to said vehicle;
a support plate adapted to support said vehicle plate, said support plate having a front surface and a back surface, said support plate disposed on each of said front surfaces of each of said forward portions of said first arm and said second arm; and
a pad disposed on said back surface of said support plate.

44. The device of claim 43, wherein said pad is made of a material selected from a group comprised of window insulation, foam rubber, leather, foam, rubber, and combinations thereof.

45. The apparatus of claim 43, wherein said device is further comprised of a pad support, said pad positioned on said pad support

46. The device of claim 43, wherein said vehicle plate is selected from a group comprised of a government-issued vehicle identification plates, a promotional design, an advertisement, a car dealer indicia, a safety marker, racing indicia, and combinations thereof.

47. The device of claim 43, wherein said support plate is constructed of a material selected from a group comprised of aluminum, plastic, Plexiglas, wood, steel, stainless steel, and combinations thereof.

48. The device of claim 43, wherein said first arm, said second arm, and said at least one crossbar are made of a material selected from a group comprised of aluminum, plastic, Plexiglas, wood, steel, stainless steel, and combinations thereof.

49. The device of claim 43, wherein said arm length adjusting mechanism is selected from a group comprised of a cotter pin, a bolt, a lock, a pin and a cotter key, a clevis pin, a detent ring pin, a lanyard, a lock pin, a split key ring, a double loop hair pin, a circle cotter, a kickout ring, a lynch pin, a crimp ring retainer, a spring ball plunger, a ball plunger, and including combinations thereof.

50. The device of claim 43, wherein said rearward portions of said first arm and said second arm are permanently secured to said vehicle or integrated to said vehicle.

51. The device of claim 43, wherein said support plate is comprised of at least one aperture.
